(19) United States
(12) Patent Application Publication
(10) Pub. No.: US 2012/0243213 A1
(43) Pub. Date: Sep. 27, 2012

(54) OUTDOOR LED LIGHT FIXTURE WITH DIMMER SWITCH

(76) Inventor: Chi Gon CHEN, Guang Zhou (CN)

(21) Appl. No.: 13/072,507

(22) Filed: Mar. 25, 2011

(51) Int. Cl. F21L 4/08

(52) U.S. Cl. 362/183

(57) ABSTRACT

The outdoor lighting fixture of the present invention provides a solar powered lighting fixture having one or more light emitting diodes whose luminance or brightness may be selectively adjusted by the user. The outdoor lighting system includes a dimmer switch mechanism in its electronic circuitry that allows a user to vary the luminance of the emitting diodes. In one embodiment, the dimmer switch mechanism modulates the pulse width of electricity provided to the one or more light emitting diodes. In another embodiment, the dimmer switch mechanism modulates the frequency of the one or more light emitting diodes. By adjusting the brightness of the light emitting diodes the operational time of the lighting fixture may also be modified.

### BACKGROUND OF THE INVENTION

1. Technical Field of the Invention

The present invention pertains to solar powered light systems such as those primarily in close proximity to residences for the purpose of illuminating walkways or providing decorative lighting; more particularly the present invention pertains to a system for controlling the light emitted by a solar powered outdoor light.

2. Description of the Related Art

In the past several years, the technology associated with solar panels and light emitting diodes has seen rapid development. Specifically, while solar panels were once almost a novelty item or an item used only in remote locations, both the cost of solar panels has decreased and the output of electrical energy from solar panels has increased. Similarly, while light emitting diodes had only limited applications for many years, both the cost of light emitting diodes has decreased and the output of light energy has increased. Accordingly, the power available from solar panels has grown to a level where the power requirements for a light emitting diode having an acceptable light output level for use in an outdoor setting can now be met with a solar panel. Similarly, the cost of both solar panels and light emitting diodes have both decreased to the point where an outdoor light fixture using electrical energy obtained from solar panels and emitting light from light emitting diodes is affordable to most homeowners.

The convergence of the development of the technology associated with solar panels and the technology associated with light emitting diodes has created a market where small outdoor lighting fixtures used to mark walkways or to enhance the appearance of landscaping are now in demand by homeowners. These small outdoor lighting fixtures include solar panels to capture light energy and then turn the light energy into electrical energy. The electrical energy is then stored in a battery and then directed, when needed, to an array of light emitting diodes which illuminate on receipt of the electrical energy obtained from the battery.

Early outdoor lighting fixtures using a solar panel to provide the electrical power for light emitting diodes simply provided continuous illumination at a fixed level of brightness when sufficient electrical power is available. While such outdoor lighting fixtures are satisfactory at providing continuous illumination at a fixed level of brightness, they did not provide users with an array of creative lighting effects. Accordingly, a need remains in the art of solar powered outdoor lighting fixtures to provide a system by which the light output of an LED may be varied to create a different effect than simple continuous illumination at a fixed level of brightness.

### SUMMARY OF THE INVENTION

The outdoor lighting fixture of the present invention provides a solar powered lighting fixture having a different lighting effect than simple continuous illumination at a fixed level of brightness. More specifically, the outdoor lighting fixture of the present invention provides a solar powered lighting fixture having one or more light emitting diodes whose brightness may be varied by the user. The outdoor lighting system includes a dimmer switch mechanism in its electronic circuitry that allows a user to vary the brightness of the emitting diodes. In one embodiment, the dimmer switch mechanism modulates the pulse width of electricity provided to the one or more light emitting diodes. In another embodiment, the dimmer switch mechanism modulates the frequency of the one or more light emitting diodes. By adjusting the brightness of the light emitting diodes the operational time of the lighting fixture may also be modified. That is, by dimming or lessening the brightness of the light emitting diodes, the operational time of the lighting fixture will be extended as compared to the operational time at full brightness. Thus, with this added functionality, users can adjust the brightness of the lighting fixture according to their individual needs when using the lighting fixture.

### BRIEF DESCRIPTION OF THE DRAWINGS

A more complete understanding of the method and apparatus of the present invention may be had by reference to the following detailed description when taken in conjunction with the accompanying drawings, wherein:

FIG. 1 is a perspective view of an embodiment of the outdoor light of the present invention mounted on a pole;

FIG. 2 is an exploded view of the embodiment of the outdoor light of the present invention shown in FIG. 1; and

FIG. 3 is an electrical schematic diagram of an embodiment of the outdoor light of the present invention illustrating the full recommended circuit incorporating an LED light with dimmer switch.

Where used in the various figures of the drawing, the same numerals designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the invention.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

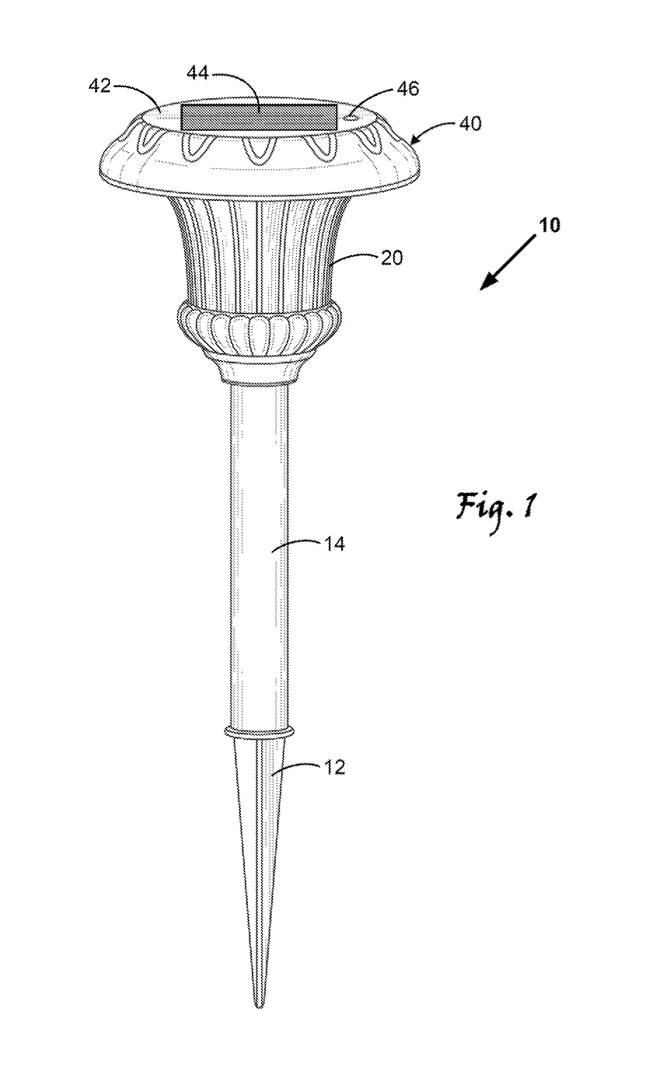

As may be seen in FIG. 1, a preferred embodiment of the outdoor LED light fixture with an integral dimmer control 10 of the present invention shown mounted on a pole 14 having a substantially cylindrical shape. A spike 12 is attached at one end of the pole 14 for securing the outdoor light fixture 10 in the ground. A light diffusing lens 20 is configured at the opposing end of the pole 14 is for the diffusion of light produced by a LED module 50. The light diffusing lens 20 may include an etched surface, a pattern (such as a waffle pattern formed or cut in the lens portion), or a coating for diffusion of light rays produced by the LED module 50. The light diffusing lens 20 may further include a reflector element 24 configured on its interior for reflecting light produced the by the LED module 50. The outdoor light fixture 10 may further include a series of connector/transition elements 13, 15, 16 which serve to connect the various parts to one another and present a visually pleasing transition from one part to another. Those of ordinary skill in the art will understand that numerous other frame assembly types and shapes may be used along with various types and shapes of light diffusing lenses.

On top of the outdoor light fixture 10 and configured over the light diffusing lens 20 is a top or lampshade element 40. The top or lampshade element 40 is constructed and configured to cover the opening 22 at the top of the light diffusing lens element 20. On the top surface 42 of the lampshade element 40 is located a solar panel 44 which receives light energy and converts light energy from the sun into electrical energy. A light sensor 46 whose utility will be explained below may also be configured on the top surface 42 of the lampshade element 40. If the solar panel 44 comprises a crystalline solar panel, then the outdoor light fixture 10 must be located where it will receive sunlight during the daylight hours. Alternatively, if the solar panel 44 comprises an amorphous solar panel, then ambient light, even on a cloudy day, will be sufficient to produce the electrical energy necessary to cause the light emitting diodes to emit light upon receipt of electrical energy.

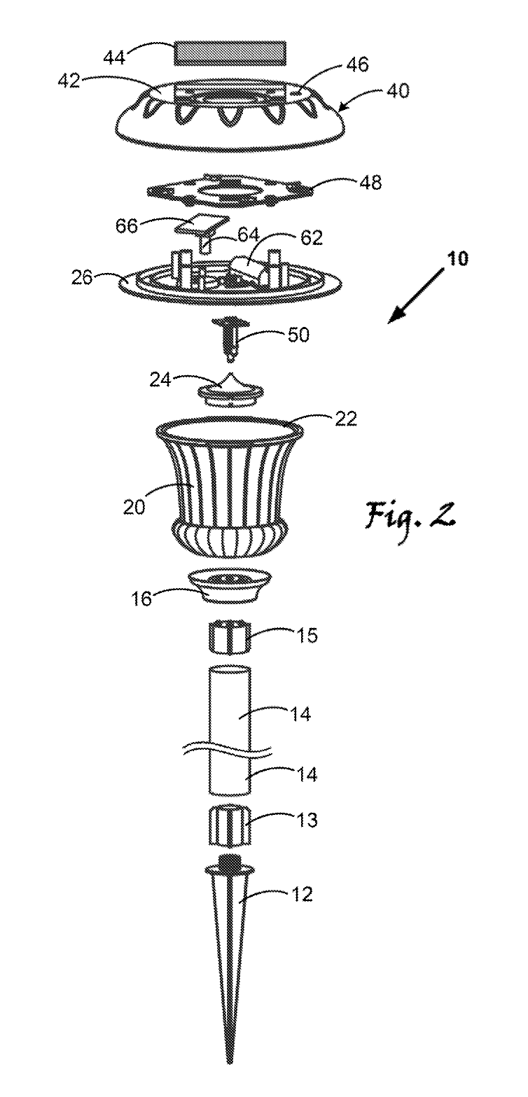

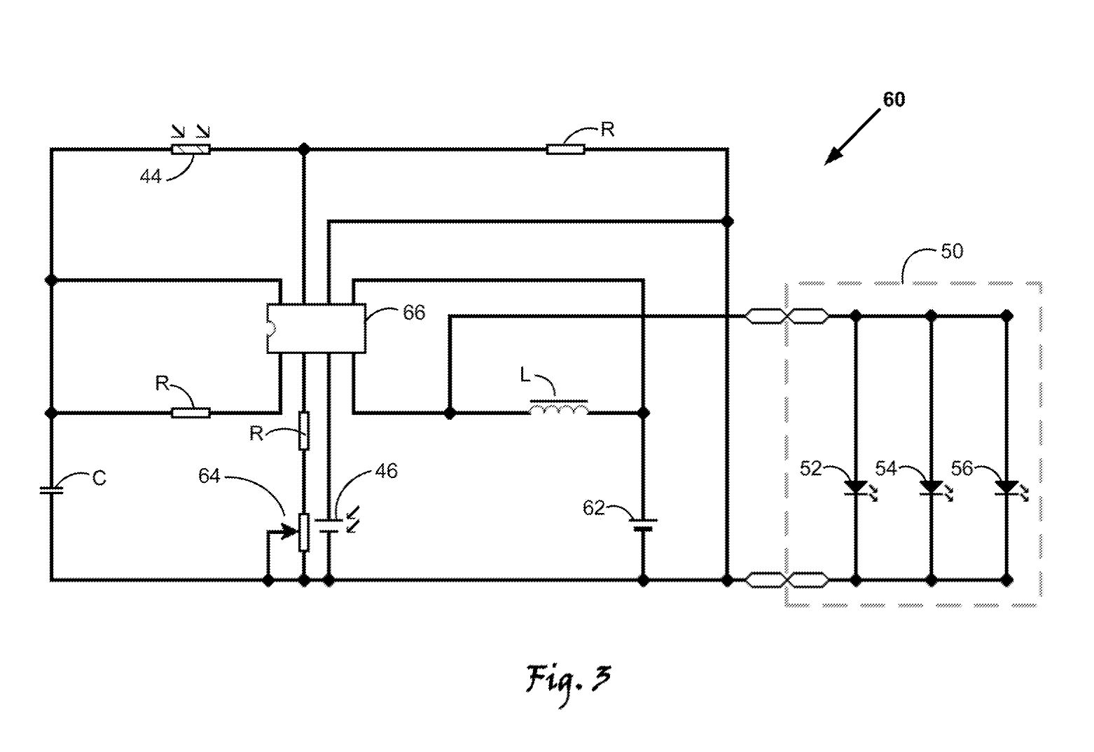

As shown in FIG. 2, configured within the top or lampshade element 40 is an arrangement of electrical componentry forming a circuit 60 (see description of FIG. 3 below) which governs the flow of electrical energy to the LED module 50 comprising one or more light emitting diodes 52, 54 and 56. The circuit 60 receives electrical energy from the solar panel 44 and directs this electrical energy to a rechargeable battery 62. The electrical energy from the rechargeable battery 62 is supplied to the LED module 50 comprising one or more light emitting diodes 52, 54 and 56 as will be explained below.

Referring now to FIG. 3, a schematic of a dimmer control circuit 60, constructed in accordance with an embodiment of the present invention, is provided. The exemplary circuit 60 is comprised of transistors configured on a printed circuit board 66, capacitors C, resistors R, a light sensor 46, light emitting diodes and a power source. The preferred embodiment is powered by a power source, such as a rechargeable battery 62 coupled to the solar panel 44. The power source 62 is used to provide current to a dimmer circuit 60 and the LED module 50 comprising one or more light emitting diodes 52, 54 and 56.

A light sensor 46 and other circuit elements are included in the preferred embodiment to turn the LED module 50 on and off when the light sensor 46 detects a certain level of light. The light sensor 46 is typically isolated from the LEDs 52, 54 and 56 so that the light sensor 46 does not receive light from the LEDs 52, 54 and 56. When the light sensor 46 detects a certain level of light above a predetermined threshold (for example, the light sensor 46 is exposed to sunlight), the light sensor 46 prevents the flow of electricity from the batter 62 to the LED module 50. Conversely, when the light sensor 46 detects a light level below a predetermined threshold (e.g., the sensor is exposed to darkness), the light sensor 46 permits the flow of electricity from the batter 62 to the LED module 50.

The circuit 60 further includes a dimmer switch mechanism 64, which allows a user to vary the brightness of the light emitting diodes. In a preferred embodiment, the dimmer switch mechanism 64 comprises a rotary variable resistor or rheostat, which is configured so that the rotary actuator extends through the bottom surface 26 of the top or lampshade element 40.

In one embodiment, the dimmer switch mechanism 64 modulates the pulse width of electricity provided to the one or more light emitting diodes. In another embodiment, the dimmer switch mechanism 64 modulates the frequency of the one or more light emitting diodes. By adjusting the brightness of the light emitting diodes the operational time of the lighting fixture may also be modified. That is, by dimming or lessening the brightness of the light emitting diodes, the rate at which the electrical circuit 60 draws electrical current from the rechargeable batter 62 is decreased. Thus, the operational time of the lighting fixture is extended as compared to the operational time at full brightness. With this added functionality, users can adjust the luminance or brightness of the lighting fixture according to their individual needs when using the lighting fixture.

While the present invention has been disclosed according to its preferred and alternate embodiments, those of ordinary skill in the art will understand the other embodiments have been enabled by the foregoing description. Such other embodiments shall be included in the scope and meaning of the appended claims.

It will now be evident to those skilled in the art that there has been described herein an improved outdoor light fixture. Although the invention hereof has been described by way of a preferred embodiment, it will be evident that other adaptations and modifications can be employed without departing from the spirit and scope thereof. The terms and expressions employed herein have been used as terms of description and not of limitation; and thus, there is no intent of excluding equivalents, but on the contrary it is intended to cover any and all equivalents that may be employed without departing from the spirit and scope of the invention.

I claim:

1. A solar powered outdoor light fixture comprising:
an electrical circuit that includes a light module having at least one light emitting diode, a solar panel connected to a rechargeable battery device, a printed circuit board for distributing electrical power from said battery device to said light module; and a dimmer switch mechanism, which is electrically connected to said printed circuit board, and controls the flow of electrical power from said battery device to said light module so as to adjust the luminance of said at least one light emitting diode in said light module.

2. The solar powered outdoor light fixture as defined in claim 1, wherein the dimmer switch mechanism comprises a rotary variable resistor.

3. The solar powered outdoor light fixture as defined in claim 1, wherein the dimmer switch mechanism modulates the pulse width of electrical power provided to the at least one light emitting diode in the light module.

4. The solar powered outdoor light fixture as defined in claim 1, wherein the dimmer switch mechanism modulates the frequency of electrical power provided to the at least one light emitting diode in the light module.

5. The solar powered outdoor light fixture as defined in claim 1, wherein said electrical circuit further includes a light sensor, which prevents the flow of electrical power from the battery device to the at least one light emitting diode in the light module when said light sensor detects a predetermined level of light.

6. The solar powered outdoor light fixture as defined in claim 5, wherein the light sensor allows the flow of electrical power from the battery device to the at least one light emitting diode in the light module when said light sensor detects ambient light below a predetermined level.

7. The solar powered outdoor light fixture as defined in claim 5, wherein said light sensor is positioned to be isolated from the light module.

8. The solar powered outdoor light fixture as described in claim 7, wherein the electrical circuit is housed in a lampshade element having a bottom connected to a light diffusing lens so that the at least one light emitting diode is contained within the light diffusing lens and the solar panel and light sensor are configured on top surface of said lampshade element which is on an opposing end of the lampshade element from said bottom.

9. The solar powered outdoor light fixture as described in claim 8, wherein the dimmer switch mechanism comprises a rotary variable resistor which extends through the bottom of the lampshade element but is not contained within the light diffusing lens.

10. The solar powered outdoor light fixture as described in claim 1, wherein said solar panel is a crystalline solar panel.

11. The solar powered outdoor light fixture as described in claim 1, wherein said solar panel is an amorphous solar panel.

12. An electrical circuit for selectively controlling the luminance of a solar powered outdoor light fixture, said circuit comprising:
a rechargeable battery device;
a solar panel electrically connected to said battery device for charging said battery device;
at least one light emitting diode;
a printed circuit board for distributing electrical power from said battery device to said at least one light emitted diode;
a dimmer switch mechanism, electrically connected to said printed circuit board, which controls the flow of electrical power from said battery device to said light module
wherein said dimmer switch mechanism enables a user to manually adjust the flow of electrical power from said battery device to said at least one light emitting diode so as to adjust the luminance of said at least one light emitting diode.

13. The electrical circuit as defined in claim 12 further comprising a light sensor, which prevents the flow of electrical power from the battery device to the at least one light emitting diode when said light sensor detects a predetermined level of light.

14. The electrical circuit as defined in claim 12 wherein the dimmer switch mechanism comprises a rotary variable resistor.

15. The electrical circuit as defined in claim 12 wherein the dimmer switch mechanism modulates the pulse width of electrical power provided to the at least one light emitting diode.

16. The electrical circuit as defined in claim 12 wherein the dimmer switch mechanism modulates the frequency of electrical power provided to the at least one light emitting diode in the light module.

17. The electrical circuit as defined in claim 12 wherein said light sensor is positioned to be isolated from the at least one light emitting diode.

18. The electrical circuit as defined in claim 13 wherein the light sensor allows the flow of electrical power from the battery device to the at least one light emitting diode when said light sensor detects ambient light below a predetermined level.

19. The electrical circuit as defined in claim 12 wherein said solar panel is a crystalline solar panel.

20. The electrical circuit as defined in as described in claim 12 wherein said solar panel is an amorphous solar panel.
